(19) United States
(12) Patent Application Publication
(10) Pub. No.: US 2016/0311105 A1
(43) Pub. Date: Oct. 27, 2016

(54) COVER REMOVING TOOL

(71) Applicant: David Syana En, El Monte, CA (US)

(72) Inventor: David Syana En, El Monte, CA (US)

(21) Appl. No.: 15/136,864

(22) Filed: Apr. 22, 2016

Related U.S. Application Data
(60) Provisional application No. 62/151,368, filed on Apr. 22, 2015.

(51) Int. Cl. B25F 1/00; B25B 7/00; B25B 15/00; B25B 5/00; B25B 9/02; B26B 11/00; B26B 13/22; B25D 3/00; H02G 1/12; B27B 21/00; B23D 71/04; B26D 3/28; B23D 75/00; B67B 7/16; A46B 15/00; A45D 29/16; B25F 1/04

(52) U.S. Cl. CPC B25F 1/003; B25F 1/04; B25B 7/00; B25B 15/008; B25B 15/005; B25B 5/00; B25B 9/02; B26B 11/003; B26B 13/22; B25D 3/00; H02G 1/1204; B27B 21/00; B23D 71/04; B26D 3/283; B23D 75/005; B67B 7/16; A46B 15/0055; A45D 29/16; G02B 25/002

(57) ABSTRACT

The invention is a tool to remove a cover from a magazine of a firearm. An exemplary tool has a handle with a contact point that is configured to interact with the side of a magazine and an arm extension that extends from the handle and interacts with an edge on the cover of the magazine. The arm has a pin such that the pin may be inserted into an aperture on the magazine cover. The cover may then be displaced through the rotation of the handle and arm extension around a fulcrum.

### RELATED U.S. APPLICATION DATA

This Non-Provisional Patent Application claims benefit of U.S. Provisional Patent Application No. 62/151,368 filed on Apr. 22, 2015, the entire disclosures of which are incorporated herein by reference.

### BACKGROUND OF THE INVENTION

1. Field of the Invention

The present invention relates to a tool, and namely, to a tool used for removing the cover of a magazine used in a firearm.

2. General Background and State of the Art

Maintenance and cleaning of a firearm is essential for its proper, safe, and accurate operation. For the military or law enforcement, routine maintenance and cleaning can make the difference in the user's ability to protect themselves or others around them. Firearm manufacturers also recognize this importance which is why virtually every firearm provides to the firearm owner the steps to disassemble the firearm for the cleaning and the replacement of parts.

However, the parts and the assembly of the firearm must be ruggedly constructed in order to withstand the high impact forces that are caused by firing projectiles. In addition, the firearms may be subjected to other rigorous field conditions. Thus, the means to disassemble the firearm often requires significant force. Such force may still be required by the existing tools that are made available by manufacturers to assist in the disassembly process.

The proper operation of a magazine of a firearm is crucial. The magazine is responsible for a chambering a round. Failure to properly chamber a round can result in a misfire or explosion. In either cases of failure, the end result may be injurious to those around. Thus, the magazine must be properly maintained which involves both the cleaning of any particulates and the replacement of interior parts which may include a follower, spring or insert plate. For example, the spring must be replaced as the spring loses its structural integrity and power to load a round into the chamber both over time and use.

In order to access such parts within the magazine, the user must remove the bottom cover or base plate of the magazine. However, it is well known to those with ordinary skill in the art that covers are not easily removed. Some may use household tools to remove the cover which can result in damage to the magazine/cover or injury to the user. In addition, some individuals may be incapable of using both hands to remove the cover from the magazine.

### INVENTION SUMMARY

The invention is a tool, and namely a tool that allows for the easy removal of the bottom cover or base plate of a magazine. The tool has an arm with an arm extension wherein the arm extension interacts with the cover. The tool also has a contact point at the end of the handle, and the contact point simultaneously interacts with the side of the magazine with the arm extension engaging the cover. By rotating the handle of the tool around the fulcrum that is created by the contact point of interaction between the side of the magazine and the tool, the tool is capable of exerting sufficient force at the area of interaction between the arm extension and cover such that the cover may be slide off the cover from an affixed point on the magazine. The contact point on the tool may be located at the end of the handle of the tool. The tool may be a multi-tool. In the alternative embodiments of the invention, the other tools may include, but are not limited to, a clamp that enables the release of locking tabs, needle nose pliers, and pin for disassembly of a fire arm. The other tools may be housed in an interior space within the cover removing tool. The interior space within the tool is large enough to house numerous other tools.

The novel features which are characteristic of the invention, both as to structure and method of operation thereof, together with further objects and advantages thereof, will be understood from the following description, considered in connection with the accompanying drawings, in which the preferred embodiment of the invention is illustrated by way of example. It is to be expressly understood, however, that the drawings or figures are for the purpose of illustration and description only, and they are not intended as a definition of the limits of the invention.

### BRIEF DESCRIPTION OF THE DRAWINGS

FIG. 1 is a top perspective view of the parts of an exemplary magazine.

FIG. 2 is a side view of the tool in a folded configuration.

FIG. 3 is a side schematic plan view of the tool in a folded configuration.

FIG. 4 is a side schematic plan view of the tool in an unfolded configuration.

FIG. 5 is a side view of the folded tool interacting with a firearm magazine cover.

### DETAILED DESCRIPTION OF THE PREFERRED EMBODIMENTS

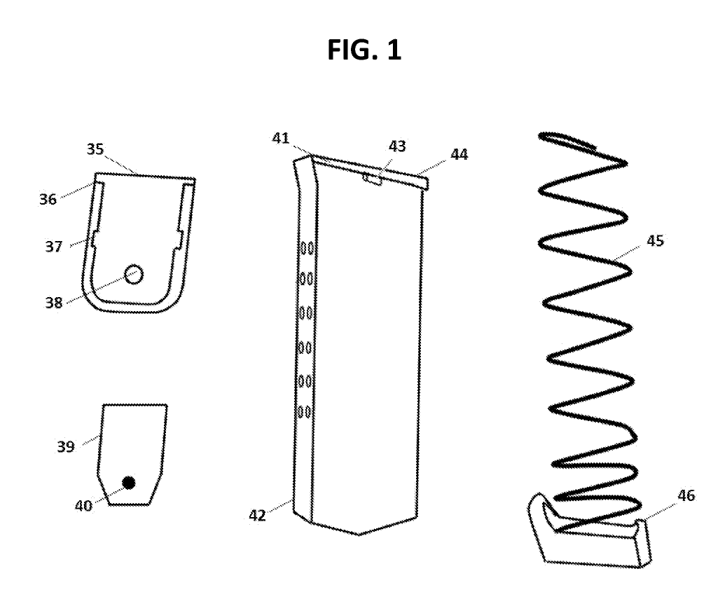

The invention is a tool 1 with a preferred purpose of providing a means to easily remove a cover 35 from a magazine 42 of a firearm. The cover 35, which may also be referred to as a base plate or a floor plate of a magazine 42, is affixed at the end of the magazine 42 opposite the end that is nearest to the follower 46. The cover 35 may be removed by sliding the cover 35 off from the opening 44 of magazine. The magazine 42 may have at least one ridge 41 disposed along and near the top edge of the opening 44 of the magazine 42. In FIG. 1, an exemplary magazine 42 which is well known to those with ordinary skill in the arts may have two ridges 41 on opposites of the magazine. The ridges 41 are configured to slide into corresponding notches 36 on the cover 35. The notches 36 may extend along opposite sides and near the edges of the cover 35 such that the cover 35 may be affixed to the magazine 42 by sliding the ridges 41 through the notches 36.

The cover 35 may have at least one aperture or depression 38 of the cover 35.

The aperture or depression 38 may be used to assist with the locking of the cover 35 to the magazine 42. It is well known by a person with ordinary skill in the art that the aperture or depression 38 of the magazine 42 may be used for aligning an additional plate that is placed inside the cover 35. The insert plate 39 may be used to hold the magazine spring 45 in its place within the magazine 42. The aperture or depression 38 may also function to assist in the removal of the cover 35. The aperture or depression 38 may be used to provide a point in which force may be applied to the cover 35 for sliding the cover 35 on or off the magazine 42. The aperture or depression 38 may be used to displace the insert plate 39 to alleviate any force exerted by the magazine spring 45 on to the cover 35.

The magazine 42 may also have at least one locking tab 43 that is used to securely affix the cover 35 on to the magazine 42. The locking tab 43 may be a protrusion on the side of the magazine 42, just below a ridge 41. The locking tab 43 may fit within a space 37 in the cover 35 which may be located in the wall of the notch 36. When the protrusion is placed within this space 37, the cover 35 may be prevented from sliding off the magazine 42 as the locking tab 43 abuts against the wall of the notch 36. The locking tab 43 may be released by squeezing the exterior sides of the magazine 42 just around the area of locking tab 43, thereby allowing the locking tab 43 to be moved inward towards the center of the magazine 42. When the locking tab 43 is moved out from the locking position, the cover 35 may slide off from the opening 44 of the magazine 42.

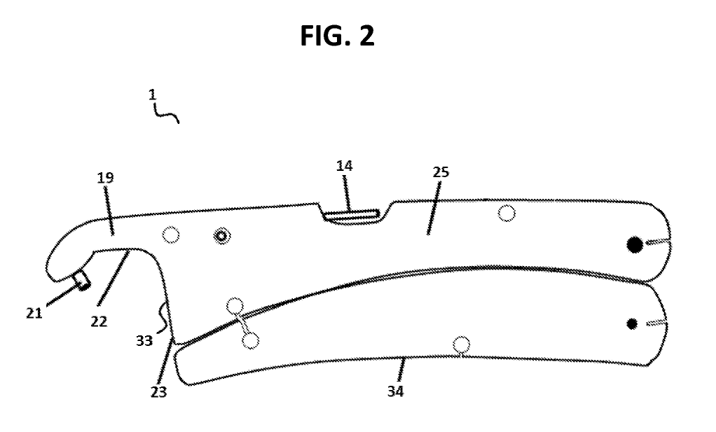

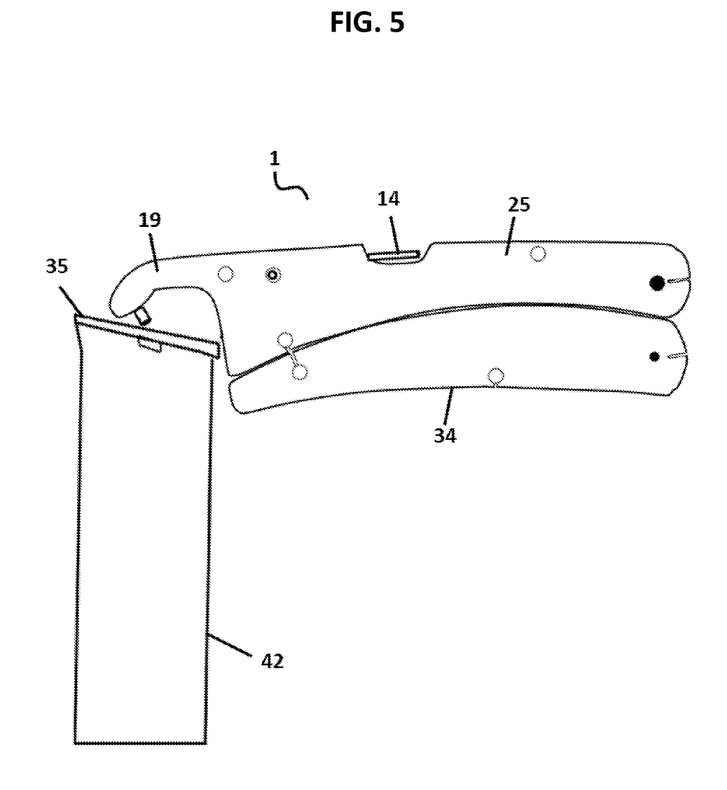

The tool 1 may be used to assist in the removal of the cover 35 from the magazine 42. The tool 1 may have a handle 25 as shown in an exemplary embodiment in FIG. 2. On a first end 33 of the handle 25, there is a contact point 23 which is configured to interact with the side of the magazine 42. The contact point 23, may be a discrete point or a broader area of the tool. The contact point 23 may be disposed at any angle with respect to the longitudinal axis of the handle. One possible embodiment is that the contact point 23 is configured to be located at the corner of the first end of the handle 25. Alternate embodiments may locate the contact point 23 at a variety of other angles from the longitudinal axis of the handle 25 so long as the angle enables the user of the tool 1 to make direct contact with the side of the magazine 42 while allowing the user to grasp the handle 25 as shown in FIG. 5. A preferred contact point 23 angle from the longitudinal axis of the handle 25 is one that allows the handle 25 to freely rotate around the contact point 23 during the operation of the tool 1. A preferred operation of the tool 1 is described further below.

On the first end 33 of the handle 25, there may also be an arm 19. In one preferred embodiment, the arm 19 may have a length that spans the full or partial length of the cover 35 when the contact point 23 is simultaneously in direct contact with the side of the magazine 42. In one embodiment, the end of the arm 19 may be configured to reach one edge of the cover 35 that is opposite from the side of the magazine 42 that is in direct contact with the contact point 23 of the tool. In this embodiment, the end of the arm 19 may have a lip or any structure that allows the end of the arm 19 to negotiate a secure interaction with the corresponding edge of the cover 35. If the cover 35 has an aperture or depression 38 that requires insertion of a pin 14 for the removal of the cover 35, the arm 19 may also have a pin 14 that is attached to the arm 19. In an alternate embodiment, the pin may be attached to the arm 19 such that the pin may be inserted into the aperture or depression 38 while the end of the arm 19 is simultaneously interacting with the edge of the cover 35, and the contact point 23 is simultaneously interacting with the side of the magazine 42.

In another embodiment of the invention, the end of the arm 19 extends to a location of the aperture or depression 38 on the cover 35 when the contact point 23 is in direct contact with the side of the magazine 42 as shown in the exemplary embodiment of FIG. 2. The end of the arm 19 may have an arm extension 21 that may be inserted into the aperture or depression 38. The arm extension 21 may have any shape so long as the arm extension's dimensions allow the arm extension 21 to sufficiently fit into the aperture or depression 38 of the cover 35. The dimensions and rigidity of the arm extension 21 ideally should engage the aperture or depression 38 with sufficient force to slide the cover 35 off the end of the magazine 42. The arm extension 21 may also have a length that is required to push or displace an insert plate 39 to help remove the cover 35 from the magazine 42. The displacement of the insert plate 39 may help to reduce the amount of force needed to slide off the cover 35 from the magazine.

Adjacent to the arm extension 21, there may be an arm surface that contacts the exterior surface of the cover 35 surrounding the arm extension 21. The interaction between the arm surface and the exterior surface of the cover 35 may allow the tool 1 to apply additional points of force against the cover's 35 exterior surface when removing the cover 35.

The tool 1 may be constructed from any material or metal alloy suitable to provide high durability and sufficient rigidity capable of sustaining forces required in the removal of the cover 35 from the magazine 42. Materials may include but are not limited to wood, plastic, rubber, or steel. Steel materials may include stainless steel, hardened steel, carbon steel, heat treated carbon steel, cold rolled steel, drop forged steel, chrome nickel steel (CrNi), chrome vanadium steel (CrV), hardened nickel based alloy, titanium alloy, inconel, forged chrome molybdenum alloy, and iron carbide.

In an alternative embodiment the tool 1 may be of a material such as a polymer material suitable to provide high durability and sufficient rigidity required for the removal of a cover 35 from a magazine 42. Polymers may include, but are not limited to, low density polyethylene, high density polyethylene, polypropylene, polystyrene, polytetrafluoroethylene, polyvinylchloride, polychlorotrifluoroethylene, meta-aramid polymer, para-aramid fiber, thermoset plastics such as polyurethane, polyesters, or derivatives thereof. The construction of the invention is not limited to a single metal or polymer, where the invention may be constructed from any combination of durable and sufficiently rigid materials.

In a preferred embodiment, the invention may be polished, treated, or coated with elements that provide the tool 1 with enhanced resistance to deterioration, abrasion, erosion, corrosion, rust, or wear and tear. For example, the tool 1 may be heat treated, have a professionally grade high-polish finish, or plated by any suitable plating technique such as but not limited to plating with chrome, titanium nitride, or aluminum titanium nitride. In alternative embodiments the tool 1 may be coated with but not limited to black oxide or a powder coat.

For an exemplary use of a preferred embodiment of a tool 1, the tool 1 may be positioned along a cover 35 of a magazine so that the arm extension 21 may be inserted into an aperture or depression 38 on the cover 35. The tool's contact point 23 simultaneously interacts with the exterior of the magazine 42. Inserting the arm extension 21 into aperture or depression 38 depresses the button 40 on the insert plate 39, and disengages the insert plate 39 within the magazine 42. The arm extension 21 may be constructed of sufficient length so as to be long enough to engage with and dislodge insert plate 39 and/or the spring 45 located within a magazine 42.

Further to this exemplary use of the preferred embodiment, the arm extension 21 may be used to slide the cover 35 off from the magazine. Following the release of the spring 45 within the magazine 42, the cover 35 may be removed by first locating the arm extension 21 into the aperture or depression 38 of the magazine 42 while locating the contact point 23 to the exterior side of the magazine 42. When first locating the arm extension 21 into the aperture or depression 38, the longitudinal axis of the handle 25 is located about ninety degrees from the longitudinal axis of the magazine 42. The site of interaction between the contact point 23 and the exterior side of the magazine 42 would be considered the site of the fulcrum. To slide the cover 35 off the magazine 42, the user rotates the handle 25 around the fulcrum, and thereby rotates the arm 19 and the arm extension 21. The rotation of the arm extension 21 causes the arm extension 21 to apply sufficient force to slide the cover 35 along the ridges 41 of the magazine 42. The cover 35 may be displaced a partial or complete distance of the opening 44 of the magazine 42 through the rotation of the handle 25 and arm extension 21 around the fulcrum.

During the removal process, the fulcrum may be located on a fixed side of the magazine 42, or the user may move the contact point 23 to another position on the exterior side of the magazine 42 that is further away from the opening 44 of the magazine 42 than the original the fulcrum location. This relocation of the contact point 23 may be necessary for certain magazines in which the arm length is not of an adequate distance or dimension that is capable of removing the cover 35 after the handle 25 is once rotated around the fulcrum. An alternative embodiment is that various embodiments of tool 1 has an adjustable arm 19 for adapting the tool 1 to the various sized magazines 42. The adjustable arm 19 may be, but is not limited to, an arm 19 with a screw that is capable of moving the end of the arm 19 to various lengths of the handle 25. Other adjustable arms 19 may include configurations that are well known by a person of ordinary skill in the art. The adjustable arm may have a locking mechanism to lock the position the adjustable arm, when in use. Adjustments may be required, but not limited to, varying locations of the aperture or depression 38, dimensions of the cover 35, and dimensions of the magazine 42.

The distance and space that are created between the arm extension 21 and the contact point 23 may have sufficient room for the entire length of the cover 35 as the cover 35 is being removed. Such space created by the structural configuration of the arm extension 21, arm 19, and contact point 23 may be necessary when the cover 35 is being slid off the magazine 42. During the tool's 1 preferred use, the cover 35 will be displaced towards the direction of the tool's arm 19. Alternative embodiments of the tool 1 may have adjustable arms 19 for accommodating various sized covers 35. An insufficient depth may prevent the tool 1 from adequately sliding off the cover 35 as the cover 35 would collide with the tools arm 19 and thereby prevent rotation of the handle 25 around the fulcrum. However, the contact point 23 may be relocated to provide for additional space between the cover 35 and the arm 19, and thus allow for additional rotation of the handle 25 around the fulcrum.

In the alternative embodiment of the tool 1, the arm 19 may extend across the length of the cover 35 while the contact point 23 interacts with the exterior side of the magazine 42. A fully extended arm end may be capable of interacting with the edge of the cover 35 in a manner that enables the end of the arm 19 to apply a force that is sufficient for sliding the cover 35 off the magazine 42. Such force may be applied upon the rotation of the handle 25 around the fulcrum.

During the preferred use of the invention, the user may desire to apply the tool 1 to a magazine 42 such that the total force applied to the cover 35 includes the force of gravity. In cases where the user may not have the use of second hand, the magazine 42 may be held in a magazine holder while the tool 1 is being employed. A holder may include a vice or a specially constructed container that is capable of applying sufficient stability to hold the magazine 42 during the operation of the tool 1. Such use of a magazine holder allows one to use only one hand to remove the cover 35 from the magazine 42.

Further to the exemplary uses of the tool 1 using one hand, the use of the tool 1 may also require the need for pressure to be exerted on the sides of the magazine 42 in order to release the locking tabs 43. In a preferred embodiment, the user may grasp the handle 25 with the middle, ring, and pinky fingers while their index finger and thumb free. The user may then apply force with the index and thumb fingers on the sides of the magazine 42 in order to release the locking tabs 43. The ability of the index and thumb to interact with the sides of the magazine are made possible by the handle being positioned approximate to the magazine such that some of the fingers of the user's grasping hand is able to squeeze the sides of the magazine.

Alternatively, an external tool such as a clamp or vise may be used. In another alternative embodiment of the invention, the tool 1 may have a clamp attached on the tool and positioned such that the attached clamp may apply the necessary pressure to the magazine in order to release the tabs. The attached clamp may provide adequate pressure around the sides of the magazine 42 for releasing the locking tabs 43 while still allowing the tool 1 for being used to remove the cover 35 off the magazine 42. The attachment may be a clamp with a hinge located between the clamp and the handle 25. The hinge allows the clamp to attach to the magazine 42, while at the same time allowing the arm extension 21 and contact point 23 from accessing the cover 35 and magazine 42 and allowing the handle to freely rotate around the fulcrum in a manner consistent with removing the cover 35 from the magazine 42.

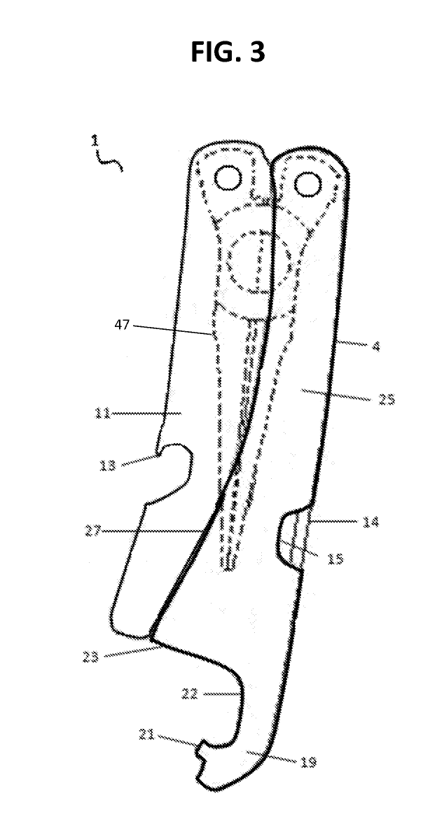

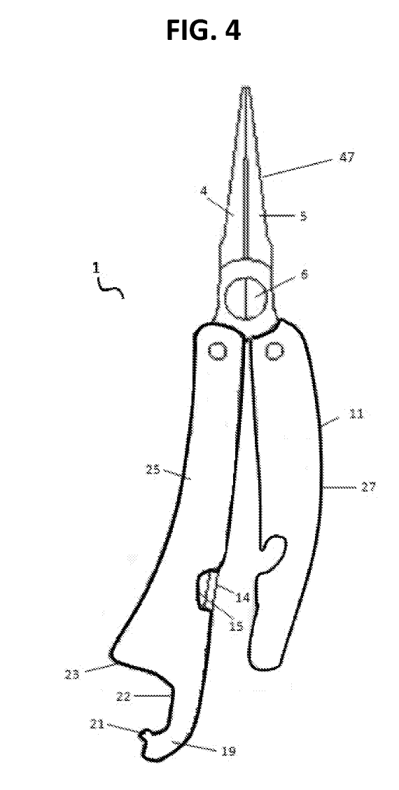

Other alternative embodiments of the tool 1 may include the incorporation of other tools. The additional tools may be added to form a multi-tool as shown in FIGS. 3-5. The additional tools may be attached and arranged in such a manner to form a compact folded configuration where no tool or only a select few tools may be used in this folded configuration as shown in FIG. 3. Further to this embodiment, the tool may be unfolded in one or more ways so that other tools may be accessed and utilized as shown in FIG. 4. Such tools may include, but are not limited to pliers 47, a pin 14, a brush, a bottle opener 13, wire cutters, scissors, one or more variety of screw/allen heads, a knife, a magnifying glass, a ruler, saw, wire stripper, combination tool, reamer, cuticle pusher, chisel, saw, file, hook, picker, key ring, tweezers, or a peeler.

The above tools may be used with a tool holder for when the tool is not in use.

The holder may have a belt clip attachment for easy wearing. Alternatively, the tool 1 may have a belt clip directly attached to the tool 1. The tool 1 may have a magnet for storing the tool against a metal wall.

While the specification describes particular embodiments of the present invention, those of ordinary skill in the art can devise variations of the present invention without departing from the inventive concept.

What is claimed is:

1. A tool for removing the bottom cover from a firearm magazine, the cover having an exterior surface that covers the bottom end of the magazine, the exterior surface having an aperture, the firearm magazine having a side wall that is near to the exterior surface of the cover, and the tool comprising:
a handle having a longitudinal axis;
a first end locating at one end of the longitudinal axis of the handle;
the first end having a contact point configured to interact with the side of the firearm magazine;
an arm connecting to at least a portion of the first end;
the arm extending from the first end in a direction along the longitudinal axis of the handle;
an arm extension locating at the end of the arm that is opposite of the first end wherein the arm extension has a portion that articulates with the aperture; and
the arm extension extending from the end of the arm in a direction that is not aligned with the longitudinal axis of the handle.

2. The tool of claim 1 in wherein the arm has a length that spans the distance of the exterior surface of the cover.

3. The tool of claim 1 in which the tool is constructed from a material suitable to provide high durability and sufficient rigidity required for the removal of the magazine cover.

4. The tool of claim 1 wherein the arm has a length that is adjustable.

5. The tool of claim 1 wherein the tool comprising at least one additional tool.

6. The tool of claim 5 wherein the additional tool comprising pliers, clamp, pin, brush, bottle opener, wire cutters, scissors, screw or allen wrench heads, knife, saw, wire stripper, combination tool, reamer, cuticle pusher, chisel, saw, file, hook, picker, key ring, tweezers, peeler, magnifying glass, ruler, belt clip, and/or magnet.

7. The tool of claim 1 wherein the handle having an interior space capable of housing at least one additional tool.

8. The tool of claim 7 wherein the additional tool comprising pliers, clamp, pin, brush, bottle opener, wire cutters, scissors, screw or allen wrench heads, knife, saw, wire stripper, combination tool, reamer, cuticle pusher, chisel, saw, file, hook, picker, key ring, tweezers, peeler, magnifying glass, ruler, belt clip, and/or magnet.
